(19) United States
(12) Patent Application Publication
(10) Pub. No.: US 2003/0169230 A1
(43) Pub. Date: Sep. 11, 2003

(54) Method and apparatus for the electronic recording of time

(76) Inventor: Peter DeVito, Surrey (GB)

Correspondence Address: Lawrence G. Fridman, Esq., SILBER & FRIDMAN, ESQS., 66 Mount Prospect Ave., Clifton, NJ, 07013-1918, US

(21) Appl. No.: 10/342,128

(22) Filed: Jan. 14, 2003

Related U.S. Application Data
(63) Continuation of application No. PCT/GB01/03144, filed on Jul. 12, 2001.

(30) Foreign Application Priority Data
Jul. 14, 2000 (GB) GB 0017373.2

(51) Int. Cl. G09G 5/00

(52) U.S. Cl. 345/156

(57) ABSTRACT

A method of electronically recording time data comprising the steps of;

using a portable device to record time data regarding time spent by a user on each of a number of tasks;

storing the time data on a removable data carrier attached to the device;

removing the data carrier from the device;

connecting the data carrier to a reader; and

reading the time data stored on the data carrier.

The portable device comprises a processor, user input means, a clock, a power supply and an interface means providing an interface to a removable data storage means, in which the user identifies the task being worked on using the user input means and the micro controller processes data from the user input means and the clock to produce the time data and passes the time data to the interface means for storage in a removable data storage means.

This is a Continuation of International Patent Application PCT/GB01/03144 having International Filing date of Jul. 12, 2001 and claiming Priority of UK Patent Application 0017373.2 Filed Jul. 14, 2000.

This invention relates to a method and apparatus for the electronic recording of time data, and in particular to a method and apparatus for electronic recording to the time spent on tasks.

Currently the most common method used to record time data, particularly in a work environment, is paper time sheets which are filled in by users and the recorded data later used for generating bills and for analysis.

Paper entry of time sheet data is both time consuming and inaccurate. It presupposes that the user enters all activities performed with start times and end times in an accurate and conscientious manner. This is unlikely. It is more likely that the time sheet is filled in at the end of a day's work or at the end of a week or period just prior to the data being needed for entry and analysis by the companies management system. This leads to the data being inaccurate as the longer the time between the logging function and the job being performed, the less accurate the data is likely to be. Furthermore it is unlikely that, in all instances, the time spent on diversionary tasks is remembered or recorded. Events such as telephone calls or group discussions with colleagues may be mis-recorded with the result that additional time is allocated to a task whilst other tasks may be under recorded.

The use of paper time sheets also increases a company's workload, in that the data usually must be manually entered into a computer system before it can be analysed. This alone may lead to inaccuracies due to missed or incorrectly entered data. Furthermore the time between the data being recorded and handed in for entry and the subsequent availability of this data for management reporting may reduce that value of that data in the management planning tasks and reaction to ongoing events.

There are other methods of data entry such as programmes on a PC that can be used to electrically record time sheet information. However use of these method are limited to people who have immediate access to a PC whilst performing their tasks and this is uncommon and is particularly unlikely for people on a shop floor environment or in the field.

Portable electronic time data recording devices have been proposed, but use of these devices has been limited. This is because they require physical connection to a host computer, using a cable, before the unit can download the recorded data. They also presuppose that the user will always enter the job change as it happens. This can be shown not to be the case as people forget to record the change, especially if the device is in another location. Another common problem is forgetting to record the times that the person arrived or left at the beginning or end of the workday.

Clearly, mis-recorded or incorrect data is a problem in a company where the timesheet information is used for billing clients directly, such as consultants and legal professionals. It is also difficult to use the recorded data for management analysis, as in tasks such as civil engineering, when the data is not available in a near real time basis. This may lead to excessive time being used on a particular task, when, if the data had been available in near real time, a trend analysis would have revealed a potential problem and remedial action taken. However, these problems are generally tolerated because of the lack of any way of solving them.

This invention is intended to overcome these problems, at least in part.

In a first aspect, this invention provides a method of electronically recording time data comprising the steps of;

using a portable device to record time data regarding time spent by a user on each of a number of tasks;

storing the time data on a removable data carrier attached to the device;

removing the data carrier from the device;

connecting the data carrier to a reader; and

reading the time data stored on the data carrier.

In a second aspect, this invention provides a method of electronically recording time data using a portable device to record time data regarding time spent by a user on each of a number of tasks, in which the recording of time data is automatically stopped at the normal work finishing time of the user.

In a third aspect, this invention provides a method of electronically recording time data using a portable device to record time data regarding time spent by a user on each of a number of tasks, in which the recording of time data is automatically started at the normal work start time of the user, the time being recorded as being spent on the same task as when the recording of time data was last stopped.

In a fourth aspect, this invention provides portable apparatus for electronic recording of time data which records the time spent by a user on each of a number of tasks comprising a processor, user input means, a clock, a power supply and an interface means providing an interface to a removable data storage means, in which the user identifies the task being worked on using the user input means and the micro-controller processes data from the user input means and the clock to produce the time data and passes the time data to the interface means for storage in a removable data storage means.

An embodiment of the invention will now be described by way of example only with reference to the accompanying diagrammatic figures, in which:

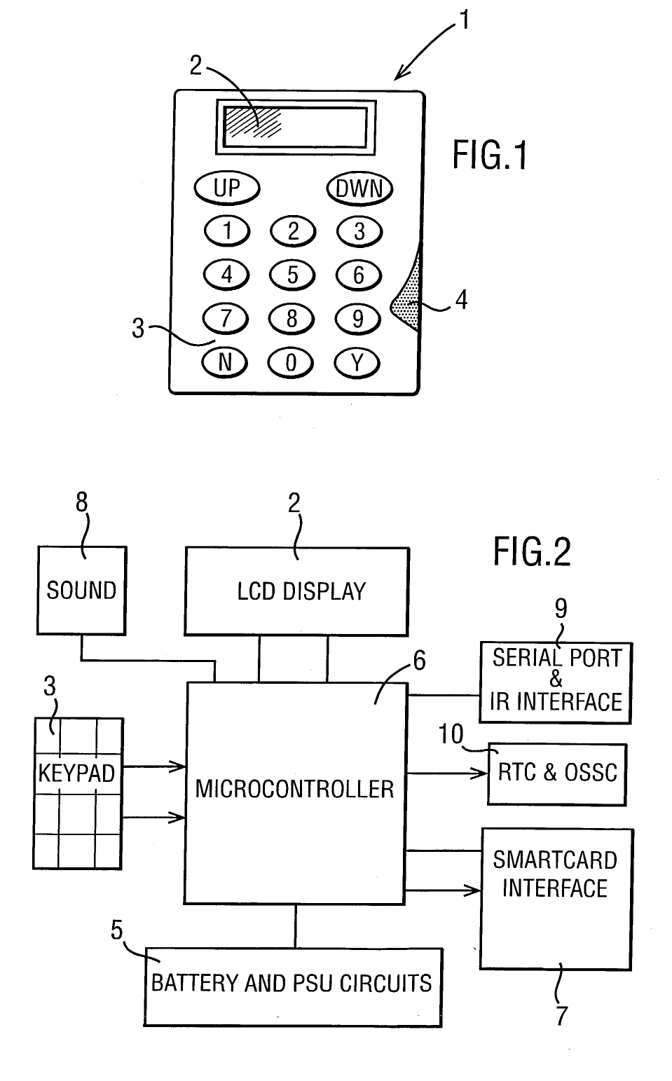

FIG. 1 shows a device according to the invention; and

FIG. 2 shows a block diagram of the internal circuitry of the device of FIG. 1.

The invention relates to a method and apparatus for electronic data capture and storage that supersedes the use of paper data entry and collection. In particular, the invention relates to a portable electronic device (typically stored in a pocket or belt clip) which logs the time spent on a specific task that can be allocated a reference number or other tag to uniquely identify the activity. The storage method for the time data and the associated job references and descriptions, is by a removable memory device, preferably a removable smart card memory (either using contact or a contact less data interface, which may contain either a memory or a memory in conjunction with a microprocessor). The smart card acts as both the storage medium for the logged time data and also the data transfer mechanism between the host computer programme and the device.

The method described below does not require the device to leave the user of the logging apparatus in order for the recorded time data to be downloaded or for the operating information of the device to be updated. The host system can issue a new set of jobs, related numbers and descriptions and other pertinent information without the device being present. The removable smart card can simply be exchanged with a new card and the logged data in the previous smart card uploaded either by a local host port (and from there via a network connection to the main system) or sent physically to the main host input station while the information from the host system is carried on the new smart card and so made available to the device. In a similar manner the same smart card could be removed from the system, inserted into a local reader and uploaded to the host and reprogrammed with new information.

The device uses smart card technology to transport data from the host system to the user and back from the user to the host system. Smart cards use a chip usually embedded in a plastic carrier that works either on a contact or contact less basis. In the contact variant, the chip communicates through a set of pads, which make physical contact with fingers in the reader device to form an electrical connection. The chip can be a memory device, a micro controller or a combination of both.

Contact less technology uses an RF field to communicate from the reader to the smart card. The smart card contains a chip bonded to an antenna which picks up both the communication (carried out by modulating the carrier) and power from the readers RF field. The smart card chip can be a memory device, a micro controller or a combination of both. Contact less technology has an advantage over contact where the unit needs to be sealed such as in harsh environments, but contact technology is usually simpler and cheaper for less demanding applications. There are a number of standards for contact less devices that cover low frequency (125 Khz), medium frequency (13.56Mhz) and high frequency (900 Mhz).

One embodiment of a device according to the invention consists of a portable electronic device 1 that is used for logging timed events into a non-volatile memory on a removable contact smart card.

Referring to FIG. 1, the time logging device 1 has an LCD display 2 for displaying numeric data and a keypad 3 to allow the user to input data to the device 1. The smart card is retained in a slot in the side of the device in order to physically protect the smart card and prevent damage to or dislodgement of the electrical connection between the smart card and the device 1. In order to allow the smart card to be removed from the device 1, a smart card release button 4 is provided on the side of the device 1.

The use of a non-volatile memory carried on a contact smart card is preferred. However, other types of recoverable data carrier could be employed. In particular, the use of a non-contact smart card or the use of a smart card carrying a volatile memory together with a power source would be possible. However, the use of a volatile memory will impose limits on use of the device, which may be inconvenient.

The events are identified by use of a job number. In the basic version of the system the unit 1 displays only numeric information on the display 2 and the user must relate the number through a list to a particular task. In an enhanced version of the device, the smart card memory also carries a text name or description of the job that can be displayed to the user for ease of use via the logger's display 2. In a preferred embodiment the logging device 1 is a portable, battery operated device that consists of the following elements.

Electronic computer board containing a microprocessor device and support circuitry

A battery or power supply circuit.

A real time clock function

A LCD display device 2 with associated electronics.

A keypad 3 connected to the microprocessor for data entry.

A smart card interface for either contact or contact less smart card technology.

A buzzer or sounder for user feedback.

A serial data port offering bi-directional direct cable connection or Infra Red connectivity to a host.

A plastic or metal external shell.

A mechanical card retaining system that can hold the smart card during use and release it when required.

In a typical embodiment, the invention is directed to a data logger for recording, in real time, the time spent on a particular task or activity by a particular user for a client. The device can be used to record time spent on several tasks, each task being allocated a pre-programmed number that uniquely identifies that task to the database on the host system. In a typical application each of the tasks is associated with a particular button on the device thus allowing rapid identification of the task to the device with minimal user input. In order to accommodate tasks that are not pre-programmed into the device the buttons can be used to enter a sequence of digits that will then be recorded as a new task.

In use, the smart card data identifying the task associated with each number and the users normal working hours will be prepared by a system administrator on a host device. This device will typically be a PC running a programme that interfaces with the management information system via common database interchange file formats such as a CSV file. It may also have direct input from a task generator that can record new tasks and allocated numbers and descriptions. The programme will output to a smart card read/write device that is connected to the PC.

The job numbers are entered into the programme and associated with a button on the portable logging device through a graphical front end. Also included in the database is the users normal working hours. This is used by the logger device 1 if the user forgets to sign on in the morning or sign off after the day's work. There is other system information that is required by the card including the reminder period, which will be described later. These options are normally set by check boxes and data entry fields on the host user interface. Once the data is entered and collated by the system it is downloaded to a smart card through the smart card read/write device. On the enhanced device the job numbers and a text description are also stored on to the smart card. The smart card is a non-volatile medium that requires no power to hold the data once it is written. The time between uploading the data to the card and the data being used by the logging device is determined only by the transport time and can be indefinite.

The card is then issued to the user, and typically, at the same time the user removes the current smart card device in the portable logger and returns this to the system administrator. The new card is then inserted in the logger and becomes the current card. The old card is inserted into the system administrator's smart card reader and the recorded data downloaded and stored on the database. It may also be exported for use by external management information system analysis.

Once the new card is inserted into the portable logging device 1, the device 1 recognises the new card and reads the task numbers, button associations and other related information. The user is then prompted via the logging device's sounder (typically by a series of tones) to “log on” to a task. The task is selected by either pressing a button and a confirm key or by entering a new task number and the confirm key. During all data entry the device gives feedback to the user on the data and options via the LCD display. Once the unit is logging it will time stamp the start time of a task and record it to the smart card memory. If the user continues with that task the device will continue to record elapsed time to a counter on the smart card. In order to allow time stamping as well as measuring of elapsed time the logging device 1 it has an on board real time clock that is set only when new batteries are required.

If programmed to do so (in the options field of the smart card) the logger 1 will prompt the user at regular intervals to confirm that the task has not altered. This is done via a tone and requires the user to press a key to clear the tone. This ensures that even if a user has started another task and forgotten to log on to it, the device will eventually prompt the user to switch tasks. The time between prompts is programmable by the host system and can be tailored for individual users. In another programmable option the user can edit the time count by a specific amount if he/she had forgotten to switch tasks and only did so at the reminder time.

During the normal day there will be time spent on non-work activity such as breaks and lunch etc, as well as on different work tasks. In order to switch from one task to another the user simply presses one of the pre-programmed task buttons (assuming that the task is a pre-programmed one) and confirms the change with the accept button. The device will terminate the logging count for the current task, time stamp it and commence logging time to the new task number. If the task number has already had time logged to it then the device logs time from that point giving a total accumulated time count since the task time counter was cleared by removal and replacement of the smart card. Typically this clearing is carried out at the end of each week, but any convenient period could be used. The display allows the user to see the current time of day, the job number and the accumulated hours. During task switching the device provides feedback via audio and LCD prompts. If a mistake was made there is an option to abort the entry and continue logging the current task.

At the end of a workday the user should log out of the system by selecting the button associated with end of day. If the user forgets to terminate his task at the end of the day the device will prompt the user by a series of tones at the time he/she is normally expected to end work. The user can chose to ignore this warning or override it, if for example they are working late. If the user does not override this warning and does not terminate a task with the end of day button then the unit will assume that the user worked a normal day and will terminate the task time count automatically. Similarly, in the morning, if the user has not started a logging task by the usual work start time then the unit will start accumulating time to the last task it was assigned to, until it is started on a new time. Each of these exceptions is logged into the smart card memory so that the host system can tell which were automated procedures and which were manually initiated.

Non-work, or non-chargeable activity can be dealt with by temporarily logging out of the system or by assigning one or more task numbers to such non-work tasks. In many applications it may be desirable to distinguish between time spent not working, for example at lunch, and time spent on functions which are a necessary working task but cannot be assigned to a particular job or client, for example training, general administration or “housekeeping” managerial tasks. In order to do this, such activity can be identified as a task and assigned one or more numbers as required.

In a preferred option, the device can also be used to record expenses or other non time related chargeable items such as travel mileage and record them against task or job numbers.

Information such as which job a particular expense, for example lunch with a client or purchase of component, is related to can be simply recorded. In most cases the user obtains a receipt for the goods or services. In known systems for recording and resolving such costs and expenses it is normal for the user to record the expenses together with the relevant job numbers onto an expenses sheet on a regular basis, for example weekly, and then submit the sheet together with the relevant receipts. The information on the sheet is then entered through a spreadsheet or similar programme so that it can be processed by an accounting system.

This process can be simplified and the risk of mistakes reduced by use of the invention.

When a purchase is made or services are paid for the user should log onto the appropriate task or job number related to the expense in the same way as the user would to begin logging time to the task or job number.

The user then presses one or more of the buttons on the device to indicate that a receipt amount should be recorded rather than time. The device then generates a six digit receipt code and displays it on a display. The user then writes the 6 digit receipt code onto the receipt and enters the receipt amount into the device using a key pad. The total value is then confirmed using a confirm key and the device then stores the receipt amount and receipt number against the identified job number on the smart card.

Preferably, the device also stores a time stamp with the receipt amount in order to provide a further check to allow receipts and recorded expense amounts to be reconciled.

When the smart card is returned to the system administrator and read, the recorded data downloaded and stored on the administrator database will include expense receipt amounts associated with the job numbers in addition to the time data. If the user provides the original receipts marked with the 6 digit receipt codes a receipt can easily be tied to the recorded expense amounts and the job numbers.

The data down loaded to the accounts information system can easily be analysed and the necessary expenses information imported automatically to an accountancy programme to generate any necessary expenses reports.

A 6 digit code needs to be unique in the sense that each receipt recorded by each user in the same week, or recording period if data is down loaded and receipts processed on a longer timescale, has a different 6 digit code.

Conveniently, the 6 digit codes can be generated by the smart card storing the last 6 digit receipt code issued in memory and incrementing this stored value by 1 to generate a new 6 digit receipt code when a new code is requested. When the user confirms the amount of the receipt allocated the 6 digit code the new 6 digit code is recorded in the smart card memory as now being the last 6 digit code issued.

In order to avoid any possible uncertainty it may be preferred to provide each smart card used in the system of the invention within a single organisation with a different initial 6 digit code, the initial 6 digit codes being spaced apart sufficiently that the issue of the same 6 digit code in the same week with different devices 1 is unlikely.

Another type of information which could be recorded is car mileage travelled distances.

Normally where travel costs can be charged to a job they will be charged as expenses and appropriate receipts obtained as explained above. However, this procedure cannot be used to record mileage travelled in company or users own vehicles because no actual expenses or receipts are involved.

It is preferred for the device to be able to record such travel mileage.

Conventionally, companies charge their clients for billable mileage travelled on a pence per mile basis. This is traditionally done by writing down the vehicle odometer start mileage or re-setting the trip meter at the start of the journey and then writing down the end mileage. Usually the mileage travelled is only formally recorded at the same time as other expenses are submitted on an expenses claim sheet and it is often difficult or impossible to definitely assign particular mileages to specific customers or jobs.

Using the present invention when the user begins a billable or chargeable journey the user logs onto the relevant task or job number on the device as before. The user then enters a code on a keypad to inform the device that a mileage is to be recorded against the job number. The code used to inform the device that a mileage is to be recorded can be depressing a dedicated mileage or travel button or it could be a specific combination of key strokes on non-dedicated keys. The device will then prompt, using the display or by sound, or both, for the current vehicle mileage to be entered. The user then enters the last 6 digits of the current vehicle odometer reading and then presses the confirm key to confirm that the start mileage entry is completed. The device records this information on the smart card as a start mileage value and preferably also time stamps the entry in order to allow easier reconciliation by the system administrator.

When the journey is completed the user re-enters the same job number and again informs the device that a mileage is to be recorded. The device then prompts for an end mileage to be provided and this is entered as the last 6 digits of the current vehicle odometer reading and confirmed. The device then records the end mileage and stores this on the smart card, again preferably with a time stamp.

When the smart card is returned at the end of the week and the data is retrieved the distance or mileage data can be extracted and the distance covered, start mileage, start time, end mileage and end time along with relevant job number are all available for administrative, analysis and billing purposes. This information can readily be down loaded to accounts programmes as required for the relevant mileage billing rate to be applied and charged.

Commonly, when a user is logged onto a particular job number to charge for time spent, any chargeable goods or services paid for and chargeable mileage travelled will usually be chargeable to the same job number and client as the time. In order to simplify operation of the device in this, most likely, situation, where the device is already logged onto a job number and is charging time against it, entering the expenses or mileage codes will allow expenses amounts and travel start mileages and end mileages to be entered without interrupting time recording.

In order to enter expenses or travel distances against a different job number from the job number against which time is currently being recorded, it is necessary to log out of time recording against the current job number and then log back into it after the expense or travel transaction has been completed.

In the examples above, a 6 digit code is generated for receipts and mileages are input as a 6 digit number. The use of 6 digit numbers is convenient as this is sufficient to deal with most vehicle odometer readings and provides sufficient possible receipt codes that avoiding the duplication of receipt codes will not normally be a problem. Smaller or larger numbers of digits could be used. There is no requirement for the receipt codes and mileage values to have the same number of digits, but in practice it is convenient for them to have the same number of digits, this being the same number of digits as the device display.

It is envisaged that the unit will hold a single weeks of time sheet logs, and other data if required, and this would typically involve 10 different job allocation numbers. By using a smart card with a larger memory more weeks of data could be stored. However this may prevent the management information system having access to this data until a time when it is too late for preventative measures to be taken based on trend analysis. It is also possible that instead of logging accumulated time the device could be used to show remaining time. The time allocated to a task would be loaded to the smart card and flags set to indicate a decremental process for that task. Once the decremented time reached zero a tone would be generated to warn the user. This could be useful where a client has pre-purchased a block of time, or where performance measurement is undertaken.

The number of job allocation numbers can be increased or decreased as necessary.

The device 1 comprises a portable housing that is robust enough to carry as a belt clip item or in a shirt or jacket pocket. It houses a smart card that can be manually inserted and ejected from the housing. The device 1 also contains a battery power supply 5, a keypad 3 for data entry and menu scrolling and an LCD display 2. It is envisaged that the power supply 5 will run from a single replaceable cell and will have a typical life expectancy of 3 months. An external view of the device is seen in FIG. 1.

Referring to FIG. 2 a block diagram of the working parts of the device 1 is shown.

The device 1 is operated and controlled by a micro controller 6. The micro controller 6 drives the LCD display 2 and receives user input information through a keypad 3. The micro controller 6 is connected to a smart card interface 7 so that the micro controller can store task and time related data in a memory on the smart card and retrieve information identifying tasks and assigning numbers to tasks from a memory on the smart card. A real time clock 10 provides the necessary time information to the micro controller 6.

The device also includes a sounder 8 to allow audible prompts to be generated under the control of the micro controller 6 as reminders to the user as explained above.

Although a smart card carried memory is used to transfer information to and from the device it will normally be convenient for the micro controller 6 to include or have access to memory on board the device 1 holding the necessary operating instructions and programs for the device 1.

A serial data port 9 is also connected to the micro controller 6 to allow bidirectional data transfer between the device 1 and a host system by direct cable connection or an infrared data link. This data link can conveniently be used to load or modify the operating instructions and software of the device 1 on initial set up or to update or upgrade the device 1. The bidirectional data link 9 can also be used to allow trouble shooting in the event of malfunction of the device 1.

The display 2 indicates the current time, the job number currently logging and other information. The buttons are typically a rubberised overlay or membrane keypad. There is a smart card release 4 that ejects the card and allows insertion of the new card. It is envisaged that to prevent false keying the keys must be held for a minimum period and any action confirmed with the Y key within a time period. The IR or serial communication port is on the topside of the device.

Conveniently the device 1 displays a warning message on the display 2 when a smart card is not present in the device 1.

The use of an LCD display is preferred, but other types of display could be used.

The embodiments described above are only preferred examples of the invention and the person skilled in the art will realise that changes and substitutions to the described examples could be made when carrying out the invention.

1. A method of electronically recording time data comprising the steps of;
using a portable device to record time data regarding time spent by a user on each of a number of tasks;
storing the time data on a removable data carrier attached to the device;
removing the data carrier from the device;
connecting the data carrier to a reader; and
reading the time data stored on the data carrier.

2. A method according to claim 1, in which the portable device reads task data identifying the tasks for which the time data is recorded from the removable data carrier.

3. A method according to claim 1 or claim 2, in which the recording of time data is automatically stopped at the normal work finishing time of the user.

4. A method according to claim 3, in which the portable device reads the normal work finishing time of the user from the removable data carrier.

5. A method according to any preceding claim, in which the recording of time data is automatically started at the normal work start time of the user, the time being recorded as being spent on the same task as when the recording of time data was last stopped.

6. A method according to claim 5, in which the portable device reads the normal work starting time of the user from the removable data carrier.

7. A method according to any preceding claim, in which, when time is continuously recorded as being spent on a single task the portable device periodically requests confirmation from the user that the task has not changed.

8. A method according to any preceding claim, in which the portable data carrier is a smart card.

9. A method according to any preceding claim, comprising the further steps of;
using the portable device to also record other data in addition to time data;
storing the other data on a removable data carrier attached to the device; and
reading the other data stored on the data carrier.

10. A method of electronically recording time data using a portable device to record time data regarding time spent by a user on each of a number of tasks, in which the recording of time data is automatically stopped at the normal work finishing time of the user.

11. A method according to claim 10, in which the portable device reads the normal work finishing time of the user from a removable data carrier.

12. A method according to claim 11, in which the removable data carrier is a smart card.

13. A method of electronically recording time data using a portable device to record time data regarding time spent by a user on each of a number of tasks, in which the recording of time data is automatically started at the normal work start time of the user, the time being recorded as being spent on the same task as when the recording of time data was last stopped.

14. A method according to claim 13, in which the portable device reads the normal work starting time of the user from a removable data carrier.

15. A method according to claim 14, in which the removable data carrier is a smart card.

16. Portable apparatus for electronic recording of time data which records the time spent by a user on each of a number of tasks comprising a processor, user input means, a clock, a power supply and an interface means providing an interface to a removable data storage means, in which the user identifies the task being worked on using the user input means and the micro controller processes data from the user input means and the clock to produce the time data and passes the time data to the interface means for storage in a removable data storage means.

17. Apparatus according to claim 16, and further comprising a display controllable by the processor to display the identity of the task against which time is currently being recorded.

18. Apparatus according to claim 16 or claim 17, in which the interface means is a smart card interface means and the removable data storage means is smart card.

19. Apparatus according to any one of claims 16 to 18 and further comprising a sound generating device.

20. Apparatus according to any one of claims 16 to 19 in which the user input device is a keypad.

21. Apparatus according to any one of claims 16 to 20, in which the apparatus also records other data in addition to time data; in which the user identifies the task the other data is to be recorded for and inputs the other data using the user input means and the microprocessor passes the other data to the interface means for storage in the removable data storage means.

22. Apparatus suitable for carrying out the method of any one of claims 1 to 15.

23. Portable apparatus for electronic recording of time data substantially as shown in or as described with reference to the accompanying figures.
